(19) United States
(12) Patent Application Publication
(10) Pub. No.: US 2016/0078497 A1
(43) Pub. Date: Mar. 17, 2016

(54) Setting Allocations and Prices in Auctions with Occasional Remarketing Ads

(71) Applicant: Google Inc., Mountain View, CA (US)

(72) Inventor: Patrick Hummel, Cupertino, CA (US)

(21) Appl. No.: 14/487,521

(22) Filed: Sep. 16, 2014

(51) Int. Cl. G06Q 30/02

(52) U.S. Cl. CPC G06Q 30/0275; G06Q 30/0277

(57) ABSTRACT

A method for setting allocations and prices for an auction including receiving a request for content for presentation in association with one or more presentation opportunities on a publisher site, determining one or more eligible content items based on the received request, determining bids associated with each eligible content item, determining a historical bid distribution for bids that have been identified when selecting content for presentation on the publisher site, determining a risk adjustment parameter that reflects a measure of confidence in the accuracy of the historical bid distribution, conducting an auction including scoring the determined eligible content items based on the historical bid distribution, their respective bids, and the risk adjustment parameter, selecting a winning content item from the eligible content items based on the auction, setting a price for the winning content item, and providing the winning content item in response to the request.

### TECHNICAL FIELD

The present specification relates to information presentation.

### BACKGROUND

The Internet provides access to a wide variety of resources. Access to these resources presents opportunities for other content (e.g., advertisements) to be provided while providing the resources. For example, when a person performs an online search, content for businesses relating to the online search can also be presented to the user. Because the content is for businesses relating to the person's search, the person will presumably be interested in the content.

Selection and presentation of content can affect a user's level of interest. If content is selected at random, a user will most likely be less interested than if content is selected for a particular user. As such, many advertisers seek to focus their advertisements toward specific users and may be willing to pay more to have their advertisements shown to those specific users.

### SUMMARY

In general, one aspect of the subject matter described in this specification can be implemented in processes that include setting allocations and prices in auctions. The process includes receiving a request for content for presentation in association with one or more presentation opportunities on a publisher site. The process further includes determining one or more eligible content items based on the received request. The process also includes, determining bids associated with each eligible content item, determining a historical bid distribution for bids that have been identified when selecting content for presentation on the publisher site, determining a risk adjustment parameter that reflects a measure of confidence in the accuracy of the historical bid distribution, conducting an auction including scoring the determined eligible content items based on the historical bid distribution, their respective bids, and the risk adjustment parameter, selecting a winning content item from the eligible content items based on the auction, setting a price for the winning content item, and providing the winning content item in response to the request.

These and other implementations may each optionally include the following features. For instance, in some implementations, selecting the winning content item comprises selecting a highest bid. In some implementations, selecting the winning content item comprises selecting between at least two highest bids.

In some implementations, determining the historical bid distribution for bids that have been identified when selecting content for presentation on the publisher site comprises determining a cumulative distribution function for the publisher site. Determining the historical bid distribution for bids that have been identified when selecting content for presentation on the publisher site may further comprise determining a probability density function using the cumulative distribution function for the publisher site. In some implementations, the risk adjustment parameter is a function of an amount of historical bid data available for the publisher site.

In some implementations, scoring the determined eligible content items based on the historical bid distribution, their respective bids, and the risk adjustment parameter includes, for each bid associated with a particular eligible content item, calculating a risk-adjusted virtual valuation based on the historical bid distribution, the particular bid, and the risk adjustment parameter. In some implementations, scoring the determined eligible content items further includes generating risk-adjusted virtual valuations as a function of the bids. In some implementations, scoring the determined eligible content items further includes generating an ironed risk-adjusted virtual valuation as a function of the bids. In some implementations, the ironed risk-adjusted virtual valuation is a non-decreasing function of the bids. In some implementations, selecting the winning content item includes ranking the eligible content items based on their corresponding ironed risk-adjusted virtual valuations.

In some implementations, setting the price for the winning content item includes selecting the price at a bottom range associated with the one or more entities that are specifically interested in the one or more content presentation opportunities. In some implementations, setting the price for the winning content item includes computing an average of a set of highest bids.

In other implementations, a method includes receiving a request for content for presentation association with one or more presentation opportunities on a publisher site, determining one or more eligible content items based on the received request, determining bids associated with each eligible content item, determining a cumulative distribution function corresponding to a distribution of bids that a plurality of advertisers have previously placed for a publisher site, determining a risk adjustment parameter that reflects a measure of confidence in the accuracy of the historical bid distribution, for each bid, calculating a risk-adjusted virtual valuation based on each respective bid, the cumulative distribution function, and the risk adjustment parameter, ranking the bids based on the calculated risk-adjusted virtual valuations and selecting a winning bid based on the ranking, setting a price for the winning bid, and providing the winning content item in response to the request.

These and other implementations may each optionally include the following features. For instance, in some implementations, the risk adjustment parameter is a function of an amount of historical bid data available for the publisher site. In some implementations, the process further comprises determining a probability density function corresponding to the cumulative distribution function, wherein the calculation of the risk-adjusted virtual valuation is further based on the probability density function. In some implementations, the process further comprises determining an ironed risk-adjusted virtual valuation that comprises a non-decreasing function.

In some implementations, selecting the winning bid includes selecting a non-highest bid as the winning bid. In some implementations, setting the price for the winning content item includes computing an average of a set of highest bids.

In some implementations, a system comprises one or more computer processors and one or more non-transitory computer readable devices that include instructions that, when executed by the one or more computer processors, causes the processors to perform processes described herein.

The details of one or more embodiments are set forth in the accompanying drawings and the description below. Other features and advantages will be apparent from the description and drawings, and from the claims.

### DESCRIPTION OF DRAWINGS

FIG. 1 is a flow chart of an example method for setting allocations and prices in auctions in response to a request for content according to a first embodiment.

FIG. 2 is a flow chart of an example method for setting allocations and prices in auctions in response to a request for content according to a second embodiment.

FIG. 3A is plot of risk-adjusted virtual valuations as a function of bids/values.

FIG. 3B is a plot of ironed risk-adjusted virtual valuations as a function of bids/values.

FIG. 4A illustrates a first ranking scenario where the highest bidder has a negative ironed risk-adjusted virtual valuation.

FIG. 4B illustrates a second ranking scenario where multiple bidders have positive ironed risk-adjusted virtual valuations.

FIG. 4C illustrates a third ranking scenario where multiple highest bidders are tied for the highest positive ironed risk-adjusted virtual valuation.

FIG. 5A illustrates a first pricing scenario where the highest bidder has the only positive ironed risk-adjusted virtual valuation.

FIG. 5B illustrates a second pricing scenario where the highest bidder has the highest positive ironed risk-adjusted virtual valuation and the second highest bidder has a positive (non-iron) risk-adjusted virtual valuation.

FIG. 5C illustrates a third pricing scenario where the highest bidder has the highest positive ironed risk-adjusted virtual valuation and the second highest bidder has a positive ironed risk-adjusted virtual valuation.

FIG. 5D illustrates a fourth pricing scenario where the highest bidders are tied for the highest positive ironed risk-adjusted virtual valuation.

FIG. 6 is a conceptual diagram of a system that may be used to implement the systems and methods described in this document.

Like reference numbers and designations in the various drawings indicate like elements.

### DETAILED DESCRIPTION

This document describes systems and techniques for setting allocations and prices for content in an auction. For example, in a remarketing scenario, an advertiser may desire to show an advertisement to a user who has previously visited the advertiser's website. The term “remarketing,” as it is used herein, refers to presenting content (e.g., an advertisement) to a user who has previously visited the content provider's website, domain, or otherwise interacted with content, an application or resource of a content provider. The content provider may recognize the previous visit, for example, through the use of cookies, tokens or other identifiers. In these instances, the remarketing content provider may be willing to bid significantly higher than other non-remarketing content providers for a given impression. However, in second-price auctions, publishers are generally unable to effectively monetize on remarketing scenarios. For example, a remarketing content provider may be willing to pay five times as much as the next highest non-remarketing content provider, but because of the use of a second price auction, the remarketing content provider only pays the publisher (in this example) about 20% of what he was willing to pay.

In order to more effectively monetize remarketing scenarios, the methods described herein determine information about the expected distribution of bids for a particular publisher, calculate corresponding probabilities, and compute risk-adjusted virtual valuation for each content provider in the auction. Based on these calculations, auction ranking and pricing is determined, as described herein.

In some implementations, in order to deter remarking content providers from decreasing their bids, the selection of a winning bidder may include a randomized mechanism. For example, if two highest ranked content providers each place bids in a middle range (e.g., where one of the content providers is a remarketer who has lowered his bid and one is not a remarketer), then the system introduces a randomized mechanism for values in that middle range. That is, if the two highest ranked content providers are treated as if they both have the highest bid, then each content provider has a 50% chance of winning the auction, even if the remarketing content provider had a slightly higher bid than the non-remarketing content provider. Ultimately, introducing the randomized mechanism deters remarketing content providers from lowering their bids because there is a chance that remarketing content providers' bids will be randomized and they will not win the auction.

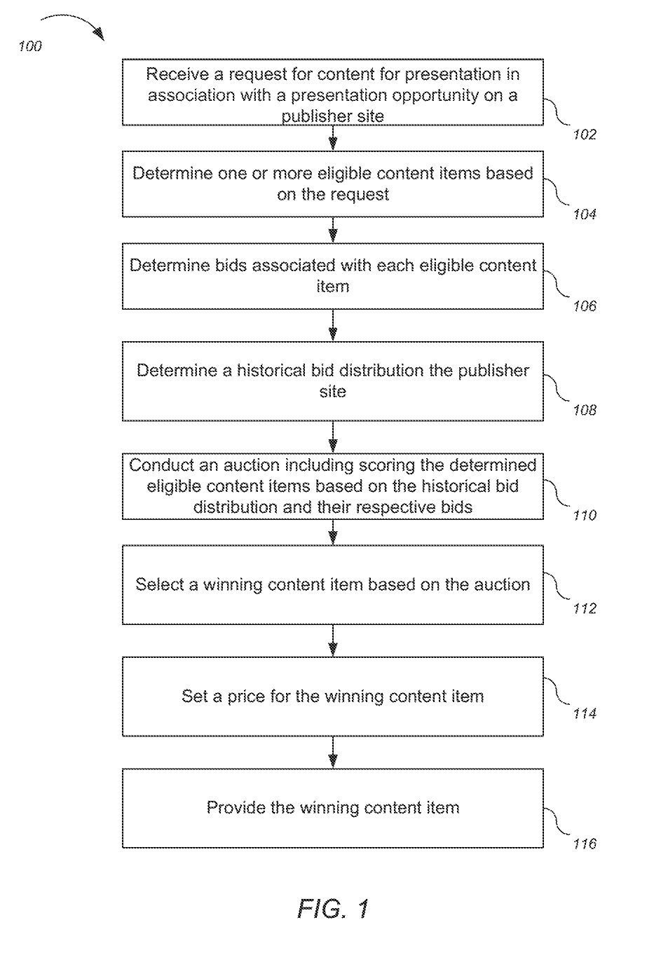

Referring to FIG. 1, a flow chart shows a method 100 for setting allocations and prices in auctions in response to a request for content. At step 102, a computing device receives a request for content, such as for presentation in one or more slots on a publisher site. This may be, for example, in a situation where a web page is to be presented to a user, and the web page includes a slot for one or more content items. The slot can be filled by submitting a request for content for presentation on the publisher site. The request may be sent to an advertising server or other content management system. The content may be in the form of an advertisement, such as a web banner, a pop-up ad, a video ad, an audio ad, or the like. The advertisement may alternatively be a keyword ad or a search ad. Other forms of sponsored content are possible.

At step 104, the computing device determines one or more eligible content items based on the received request. The one or more eligible content items may be in the form of advertisements. The eligible content items can be in inventory and sourced by various content providers who may be, for example, advertisers hoping to attract customers to their web sites. At step 106, the computing device determines bids associated with each eligible content item. The content providers that provide the one or more eligible content items submit their respective content items with a bid associated with the content item. The bid is somewhat reflective of the value that the particular content provider places on the particular slot. For example, if a remarketing content provider (e.g., advertiser) knows that the slot is located on a web page that will be displayed to a user on the content provider's customer list (e.g., a list of users who have previously visited the content provider's web site), that content provider would likely place a higher value on the particular slot that a different content provider who has had no prior interactions with the user. If an advertiser determines than an advertising opportunity is available to present content to a user on the customer list, that advertiser would likely be willing to pay more than a non-remarketing advertiser because of the higher probability that the user will be interested in the advertiser and generate a conversion.

At step 108, the computing device determines a historical bid distribution for bids that have been identified when selecting content for presentation on the publisher site. Various methods can be used to determine the historical bid distribution. The paper, “Optimal Auctions” by Roger Myerson (published in Mathematics of Operations Research in 1981) developed a theoretically optimal way to conduct an auction for a single content presentation opportunity when one knows the exact distribution from which bidder values are drawn. While this is a useful benchmark, the methods described herein instead focus on how to best conduct an auction where one's measure of the distribution from which bidder values are drawn is imprecise and simply applying the Myerson (1981) framework could lead to significant revenue loss if the measure of this distribution is too imprecise. In some instances, a cumulative distribution function (CDF) is measured, which corresponds to the distribution of the effective cost per thousand impressions (eCPM) bids that content providers have placed on a given publisher web site. A CDF reflects the range of bids that content providers have historically made on a particular publisher web site and how frequently content providers have placed bids of each value. In some instances, the CDF is used to compute a probability density function for the CDF. Because the calculated distributions are estimates, the distributions may not be exact. In some instances, a parameter that represents a risk adjustment is used that indicates an extent to which one wishes to be cautious in trying to charge content providers higher prices when there is a risk that mismeasuring the distributions could cause revenue loss. This risk adjustment parameter, α, reflects how much the system will adjust a virtual valuation of a presentation opportunity (e.g., an ad slot) in response to calculated distributions. Risk adjustment parameter, α, may normalized and be described in the interval [0,1]. If there is high confidence in the calculated distribution, then the risk is determined to be low, so α is set closer to 0. If there is low confidence in the calculated distribution, then the risk is determined to be high, so α is set closer to 1. The risk adjustment factor may be reflective of an amount of historical bid data that is available for a particular publisher. If a lot of historical bid data is available, there is higher confidence in the calculated distribution than if not much historical bid data is available. The risk adjustment may also reflect a level of accuracy in the estimated distributions of bids.

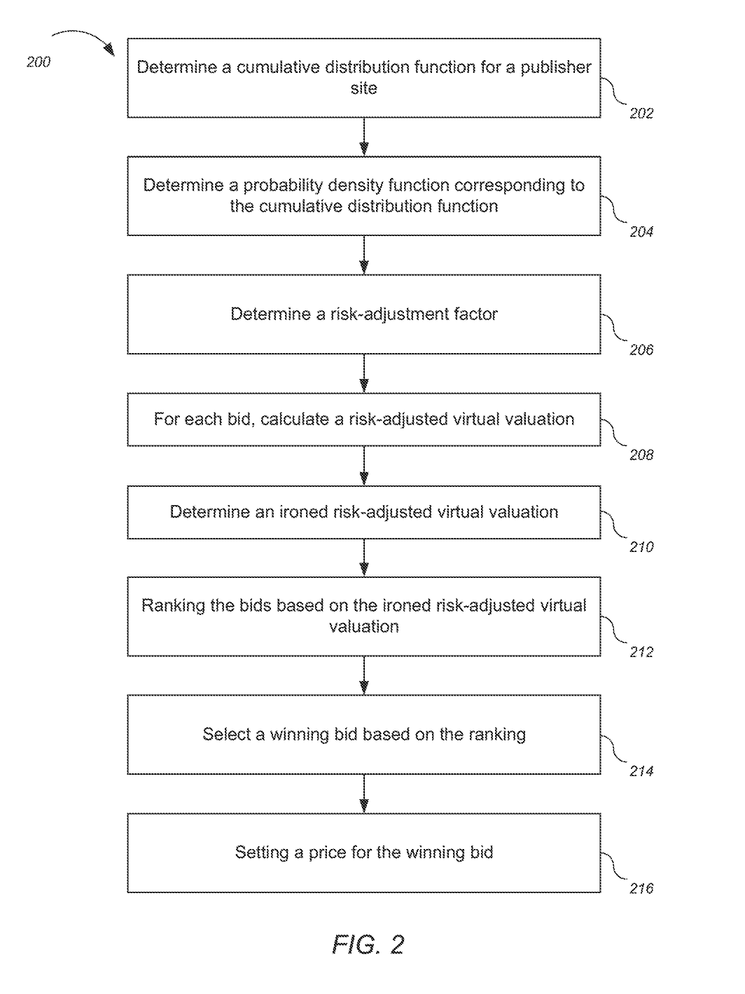

At step 110, the computing device conducts an auction including scoring the determined eligible content items based on the historical bid distribution and their respective bids. Scoring the determined eligible content items based on the historical bid distributions and their respective bids may include, for example, calculating a risk-adjusted virtual valuation for each content provider that placed a respective bid. In some implementations, each calculated risk-adjusted virtual valuation is a function of a particular content provider's eCPM bid, the CDF, the PDF, and the risk adjustment parameter. Calculation of the risk-adjusted virtual valuation will be discussed in more detail below with respect to FIG. 2.

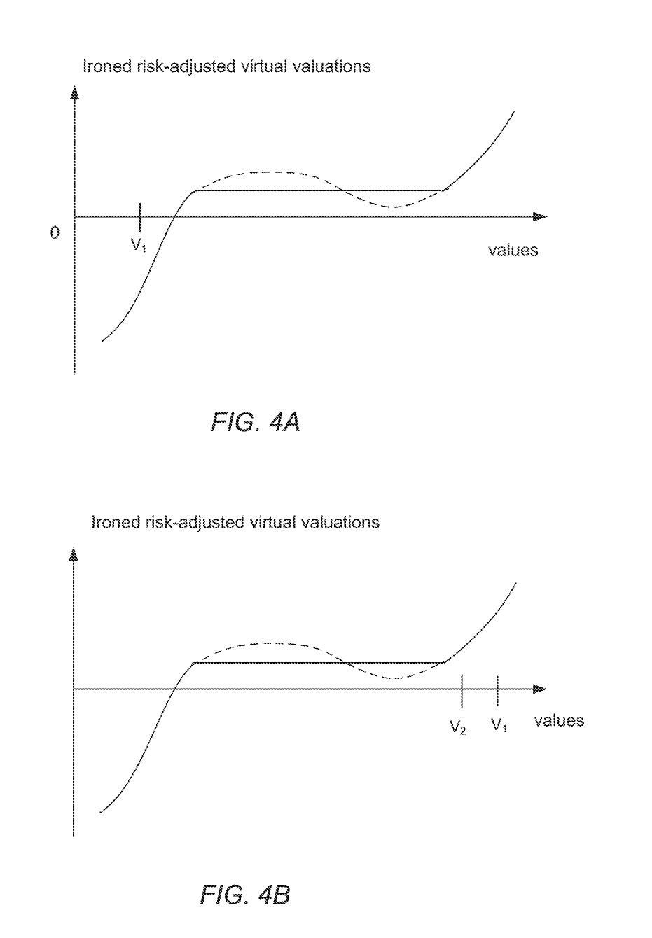

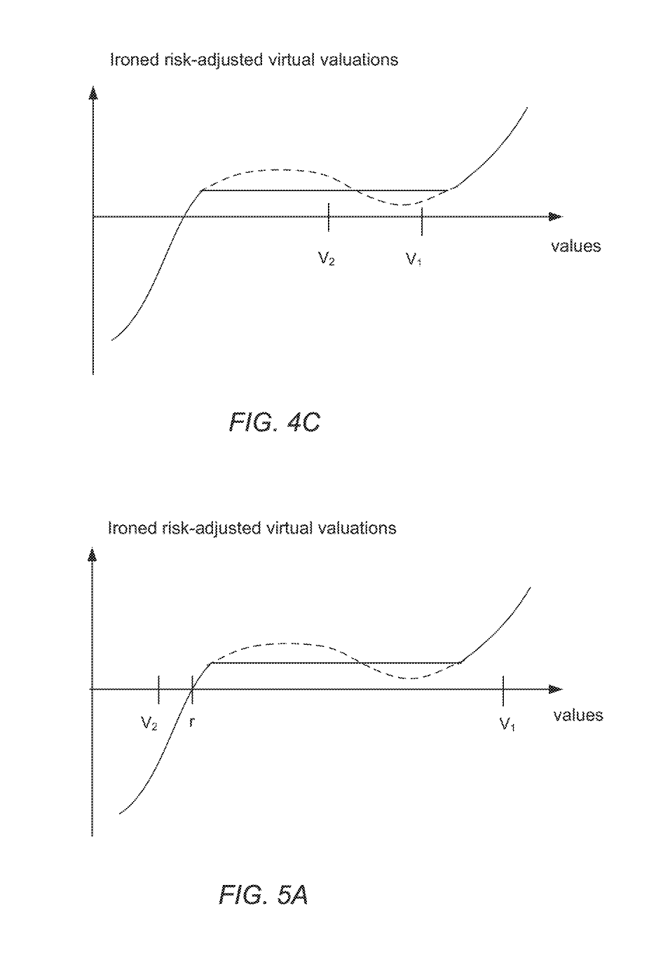

At step 112, the computing device selects a winning content item from the eligible content items based on the auction. The winning content corresponds with the highest bid of the auction, or, in some instances, one of the next highest bids of the auction (such as when randomization has been applied). Various examples of selecting a winning content item and winning bid are described below with respect to FIGS. 4A-C. One example where the highest bid of the auction does not necessarily win the auction is discussed below with respect to FIG. 4C. Allowing for a system that does not necessarily select the highest bid in an auction as a winner of the auction deters possible underbidding by remarketers.

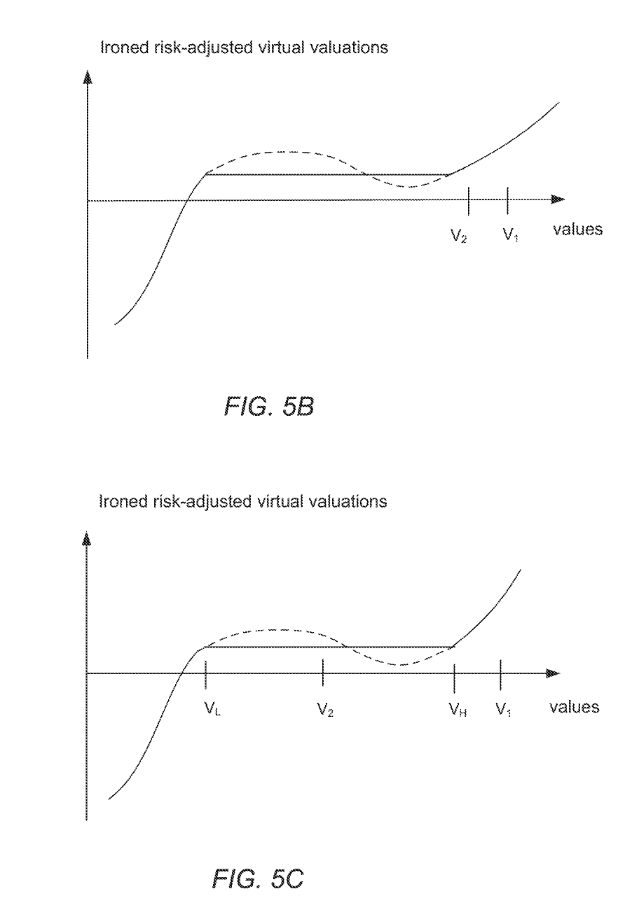

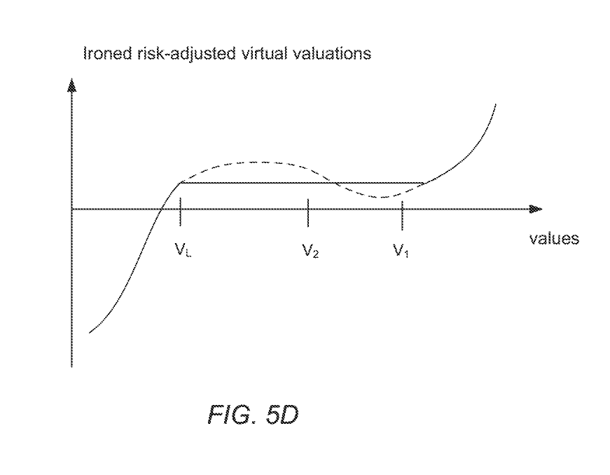

At step 114, the computing device sets a price for the winning content item. FIGS. 5A-D and the accompanying text describe various scenarios and how a price is set for a winning bid and content item. At step 116, the computing device provides the winning content item in response to the request.

Various methods may be used to employ an expected distribution of bids for a particular auction to select a winning bid and set a price for the winning bid in response to a request for content for presentation. Referring to FIG. 2, a CDF may be used, which corresponds to the distribution of the eCPM bids. In step 202, a CDF, F(v), is determined or measured. The CDF corresponds to a particular distribution of eCPM bids that content providers have previously placed on a given publisher site. eCPM is calculated by dividing total earnings by total number of impressions in thousands. eCPM can be used as a performance measure to compare various content units. A CDF reflects the range of bids content providers have historically placed on a particular publisher site and contain information about how frequently content providers have bid a particular value.

In step 204, a probability density function (PDF),

$$f ( v ) ≡ \frac{d}{d v} F ( v )$$

is computed for the CDF. The PDF describes the relative likelihood that a particular value bid will be placed by a content provider for a content presentation opportunity.

In step 206, a parameter α (e.g., in the interval [0,1]) that represents a risk adjustment parameter is determined. As described above, the risk adjustment parameter can indicate an extent or measure to which one wishes to be cautious in trying to charge content providers higher prices when there is a risk that mismeasuring the distributions in steps 202 and 204 could cause revenue loss (such as when used to set prices and to determine in which circumstances one should randomize the allocation of advertisements). If there is high confidence in the calculated distribution, then the risk is determined to be low, so α in this example is set closer to 0. If there is low confidence in the calculated distribution, then the risk is determined to be high, so α in this example is set closer to 1.

In some implementations, the calculation of the risk adjustment factor may be based on the amount of historical data that is available to measure the distribution from which bidder values are drawn. If there is a large amount of historical data that is available to measure the distribution, then there may be high confidence in the measured distribution, and α may be set closer to 0. If there is a small amount of historical data that is available to measure this distribution, then there may be low confidence in the measured distribution, and α may be set closer to 1.

As an example implementation, suppose that there have been n auctions on a particular publisher in a particular time period. In this case, the risk adjustment factor α may be calculated by setting α equal to

$$\frac{1}{\sqrt{n + 1}} .$$

More generally, α may be set to be equal to any non-increasing function of n, y(n), such that 0≦y(n)≦1 for all n.

In step, 208, a risk-adjusted virtual valuation is calculated for each content provider's bid based on one or more of the respective bid, the CDF, the PDF, or the risk adjustment parameter. In some implementations, the risk-adjusted virtual valuation represents the relative probability that a bid in a narrow range will be received. For example, if vᵢ denotes content provider i's eCPM bid in a particular auction, content provider i's risk-adjusted virtual valuation \tilde{v}ᵢ can be computed

$${\tilde{v}}_{i} ≡ {v}_{i} - ( 1 - α ) \frac{1 - F ( {v}_{i} )}{f ( {v}_{i} )} .$$

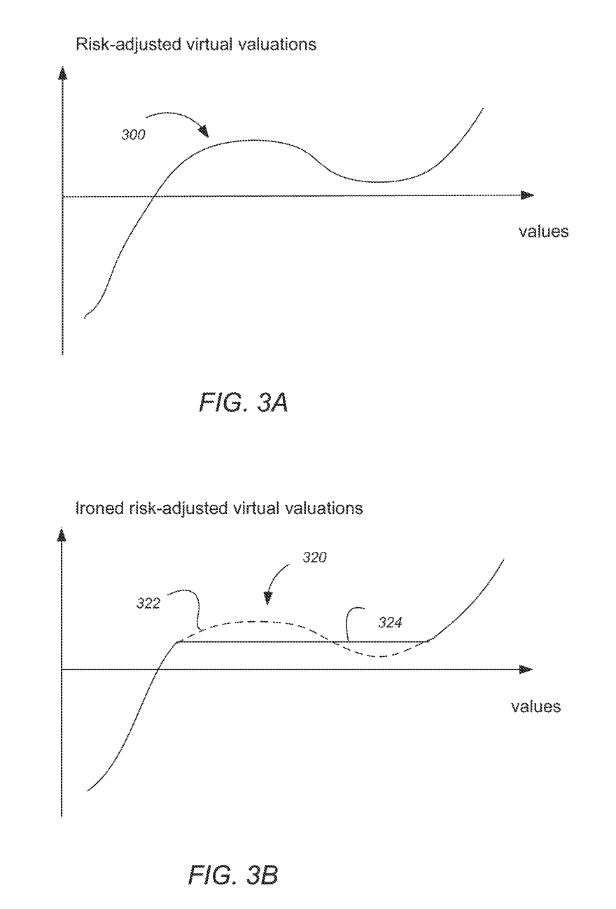

FIG. 3A shows an example plot 300 of risk-adjusted virtual valuations as a function of content provider bids/values.

At step 210, ironed risk-adjusted virtual valuations are determined. For all q ∈ [0,1], let

$$h ( q ) ≡ {F}^{- 1} ( q ) - ( 1 - α ) \frac{1 - q}{f ( {F}^{- 1} ( q ) )}$$

and let H(q)≡∫ₒ^{q}h(r)dr. Also, let G(q) denote the convex hull of H(q) or the largest convex function satisfying G(q)≦H(q) for all q ∈ [0,1] and let

$$g ( q ) ≡ \frac{d}{d q} G ( q ) .$$

The ironed risk-adjusted virtual valuation for a content provider with value vᵢ is then g(F⁻¹(vᵢ)). FIG. 3B shows the plot 320 of the ironed risk-adjusted virtual valuation as a function of bids/values. The non-ironed risk-adjusted virtual valuation 300 is shown in FIG. 3A. As shown in FIG. 3B, the areas of the plot denoted by a dashed line 322 have been “ironed” and replaced by a flat, “ironed” line 324 in the plot. In some implementations, the ironing is performed at a mid-value range in the distribution of risk-adjusted virtual valuations. The exact mid-range is based on the particular distribution, but the result of the ironing is a non-decreasing risk-adjusted virtual valuation as a function of the bids/values. In some implementations, the determination of where to iron the risk-adjusted virtual valuation is based on the location of a convex hull in the risk-adjusted virtual valuation plot. In some implementations, the goal is to choose the smallest convex function that meets certain criteria that approximately equalizes the areas. In some implementations, the goal in choosing where to iron is to approximately equalize areas in the risk-adjusted virtual valuation plot. In other implementations the determination of where to iron the risk-adjusted virtual valuation is based on a location of the largest convex function that is less than or equal to an integral of the risk-adjusted virtual valuation plot.

At step 212, the content providers are ranked in order of their ironed risk-adjusted virtual valuations. At step 214, a winner is selected based on the ranking. In some implementations, determining which content provider wins the auction, three special case scenarios may be considered. FIG. 4A shows a first scenario where the highest bid, v₁, has a negative ironed risk-adjusted virtual valuation. In this situation, the system may decide that no content provider wins the auction, and no content is displayed responsive to the received request. This scenario may be described mathematically: if the ironed risk-adjusted virtual valuation for content provider i, g(F⁻¹(vᵢ)), satisfies g(F⁻¹(vᵢ))≦0 for all i, then no content provider wins the auction. FIG. 4B shows a second scenario where a highest bid, v₁, has the highest positive ironed risk-adjusted virtual valuation. In this situation, the content provider who bid a value of v₁ wins the auction. This scenario may be described mathematically: if content provider i has the highest ironed risk-adjusted virtual valuation, g(F⁻¹(vᵢ)), and no other content provider has the same risk-adjusted virtual valuation as content provider i, and g(F⁻¹(vᵢ))>0, then content provider i wins the auction. FIG. 4C shows a third scenario in which two bids, v₁ and v₂, are tied for the highest positive ironed risk-adjusted virtual valuation. In this scenario, the two content providers who bid v₁ and v₂ win the auction with a probability of ½. This scenario may be described mathematically: if there are multiple content providers who are all tied for having the highest ironed risk-adjusted virtual valuation, g(F⁻¹(v)), and g(F⁻¹(v))>0 for each of these content providers, then each of these content providers wins the auction with a probability of

$$\frac{1}{n} ,$$

where n denotes the number of content providers who are tied for having the highest ironed risk-adjusted virtual valuation.

At step 216, a price is set for the winning content provider. In some implementations, when setting prices, the following four special case scenarios may be considered. FIG. 5A shows a first scenario where the bidder who placed the highest bid v₁ has the only positive ironed risk-adjusted virtual valuation. In such a situation, the bidder who placed winning bid v₁ wins the auction and pays price r. Explained mathematically, if content provider i has an ironed risk-adjusted virtual valuation, g(F⁻¹(vᵢ)) satisfying g(F⁻¹(vᵢ))>0 and all other content providers j have ironed risk-adjusted virtual valuations satisfying g(F⁻¹(vᵢ))≦0, then content provider i pays a price equal to the largest v for which g(F⁻¹(v))=0. In FIG. 5A, the largest v for which g(F⁻¹(0)=0 is the price r.

FIG. 5B shows a second scenario where the highest bidder placed bid v₁ and the second highest bidder placed bid v₂. Both v₁ and v₂ have positive (non-ironed) risk-adjusted virtual valuations. In this scenario, the bidder who placed bid v₁ wins the auction and pays price v₂. Explained mathematically, suppose content provider i has the highest ironed risk-adjusted virtual valuation, g(F⁻¹(vᵢ)), no other content provider has the same ironed risk-adjusted virtual valuation as content provider i, and g(F⁻¹(vᵢ))>0. Also, suppose that if content provider j has the second highest ironed risk-adjusted virtual valuation that g(F⁻¹(vᵢ))>0 and g(F⁻¹(v)) is strictly increasing in v for all v in some small neighborhood of vⱼ (e.g., the neighborhood being defined in terms of a range near and including vⱼ), then content provider i pays a price vⱼ.

FIG. 5C shows a third scenario where the high bidder has the highest positive ironed risk-adjusted virtual valuation, v₁, and second highest bidder has a positive risk-adjusted virtual valuation, v₂, that is ironed. In this scenario, the bidder who placed a bid of v₁ wins the auction and pays a price

$$\frac{{v}_{H} + {v}_{L}}{2} .$$

Explained mathematically, suppose content provider i has the highest ironed risk-adjusted virtual valuation, g(F⁻¹(vᵢ)), no other content provider has the same ironed risk-adjusted virtual valuation as content provider i, and g(F⁻¹(vᵢ))>0. Also, suppose that if content provider j has the second highest ironed risk-adjusted virtual valuation that g (F⁻¹(vⱼ))>0 and there is some small neighborhood (e.g., as described above) of vⱼ for which g(F⁻¹(v)) is independent of v. Finally, let m denote the number of content providers who have ironed risk-adjusted virtual valuations, g(F⁻¹(v)), equal to g (F⁻¹(vⱼ)). Then if v_{H} denotes the highest value for which g(F⁻¹(v_{H}))=g (F⁻¹(vⱼ)), and v_{L} denotes the lowest value for which g(F⁻¹(v_{L}))=g(F⁻¹(vⱼ)), then content provider i pays a price of

$$\frac{m - 1}{m} {v}_{H} + \frac{1}{m} {v}_{L} .$$

FIG. 5D shows a fourth scenario where the two highest bidders are tied for the highest positive ironed risk-adjusted virtual valuation, v₁ and v₂. In this scenario, each of the bidders wins the auction with probability ½ and pay price v_{L}, conditional on winning the auction. Explained in mathematical terms, suppose there are multiple content providers who are all tied for having the highest ironed risk-adjusted virtual valuation, g(F⁻¹(v)), and g(F⁻¹(v))>0 for each of these content providers. Then, if v_{L} denotes the lowest value for which g(F⁻¹(v_{L}))=g(F⁻¹(vᵢ)), where g(F⁻¹(vᵢ)) denotes the ironed risk-adjusted virtual valuation of one of the content providers who is tied for having the highest ironed risk-adjusted virtual valuation, then the winner of the auction pays a price equal to v_{L}.

After a winning bid is selected and a price is set, the content item associated with the winning bid is presented in response to the request, and the content provider who placed the winning bid is charged the set price.

This methods described herein differ from existing methods for setting prices for content providers primarily in that it combines measures of one or more of a CDF, a pdf, and/or a risk adjustment parameter to create an ironed risk-adjusted virtual valuation that is then used in auction ranking and pricing.

This methodology has several advantages over existing methods to set allocations and prices in auctions. First, the methodology enables one to charge relatively high prices to content providers who are an unusually good match (e.g., remarketers) for a particular query even in situations where reserve prices are ineffective. Second, the methods presented provide an optimal way to set allocations and prices in auctions for a single content presentation opportunity when one wishes to maximize a weighted average of efficiency (total value) and revenue. Finally, the methods presented enable one to set a risk adjustment parameter to adjust how aggressively one wishes to use measures of the cumulative distribution function and the probability density function to tweak ranking and pricing in an auction.

Furthermore, the value of this risk adjustment parameter may be optimized on a query-by-query basis and set to different values for different queries. For example, in queries that are from a publisher where a lot of data on past bids is available and confidence is high in the calculated CDFs and PDFs, it may be determined that there is small risk that the distribution measurement is incorrect. In those instances, a risk adjustment parameter that is, for example, closer to zero can be used. By contrast, if the query is for a publisher where very little data on bids that have been made historically is available and there is little confidence in the measures of the CDFs and PDFs, a risk adjustment parameter, for example, closer to one may be used to reflect the low level of confidence.

These and other services may be implemented in a server system. A server system may be a combination of hardware and software that provides a service or a set of services. For example, a set of physically separate and networked computerized devices may operate together as a logical server system unit to handle the operations necessary to offer a service to hundreds of individual computing devices.

In various implementations, operations that are performed “in response” to another operation (e.g., a determination or an identification) are not performed if the prior operation is unsuccessful (e.g., if the determination was not performed). Features in this document that are described with conditional language may describe implementations that are optional. In some examples, “transmitting” from a first device to a second device includes the first device placing data into a network for receipt by the second device, but may not include the second device receiving the data. Conversely, “receiving” from a first device may include receiving the data from a network, but may not include the first device transmitting the data.

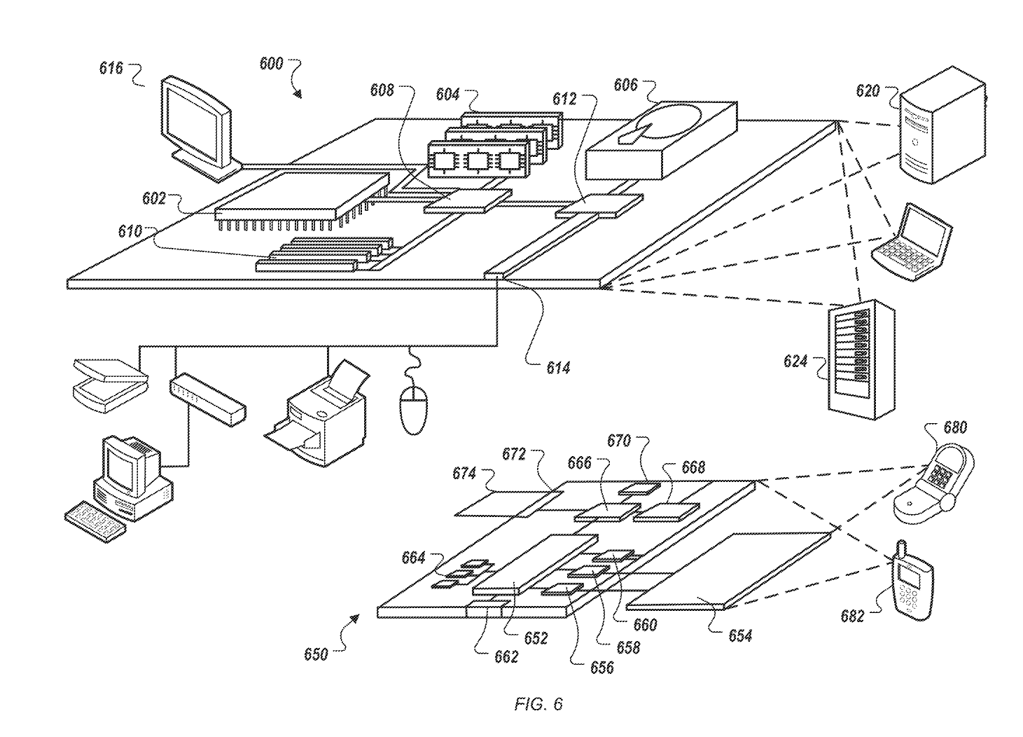

FIG. 6 is a block diagram of computing devices 600, 650 that may be used to implement the systems and methods described in this document, as either a client or as a server or plurality of servers. Computing device 600 is intended to represent various forms of digital computers, such as laptops, desktops, workstations, personal digital assistants, servers, blade servers, mainframes, and other appropriate computers. Computing device 650 is intended to represent various forms of mobile devices, such as personal digital assistants, cellular telephones, smartphones, and other similar computing devices. Additionally computing device 600 or 650 can include Universal Serial Bus (USB) flash drives. The USB flash drives may store operating systems and other applications. The USB flash drives can include input/output components, such as a wireless transmitter or USB connector that may be inserted into a USB port of another computing device. The components shown here, their connections and relationships, and their functions, are meant to be exemplary only, and are not meant to limit implementations described and/or claimed in this document.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a volatile memory unit or units. In another implementation, the memory 604 is a non-volatile memory unit or units. The memory 604 may also be another form of computer-readable medium, such as a magnetic or optical disk.

The storage device 606 is capable of providing mass storage for the computing device 600. In one implementation, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 604, the storage device 606, or memory on processor 602.

The high speed controller 608 manages bandwidth-intensive operations for the computing device 600, while the low speed controller 612 manages lower bandwidth-intensive operations. Such allocation of functions is exemplary only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device, such as device 650. Each of such devices may contain one or more of computing device 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can execute instructions within the computing device 650, including instructions stored in the memory 664. The processor may be implemented as a chipset of chips that include separate and multiple analog and digital processors. Additionally, the processor may be implemented using any of a number of architectures. For example, the processor 610 may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT (Thin-Film-Transistor Liquid Crystal Display) display or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provide in communication with processor 652, so as to enable near area communication of device 650 with other devices. External interface 662 may provide, for example, for wired communication in some implementations, or for wireless communication in other implementations, and multiple interfaces may also be used.

The memory 664 stores information within the computing device 650. The memory 664 can be implemented as one or more of a computer-readable medium or media, a volatile memory unit or units, or a non-volatile memory unit or units. Expansion memory 674 may also be provided and connected to device 650 through expansion interface 672, which may include, for example, a SIMM (Single In Line Memory Module) card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provide as a security module for device 650, and may be programmed with instructions that permit secure use of device 650. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, or memory on processor 652 that may be received, for example, over transceiver 668 or external interface 662.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, WiFi, or other such transceiver (not shown). In addition, GPS (Global Positioning System) receiver module 670 may provide additional navigation- and location-related wireless data to device 650, which may be used as appropriate by applications running on device 650.

Device 650 may also communicate audibly using audio codec 660, which may receive spoken information from a user and convert it to usable digital information. Audio codec 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smartphone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. Moreover, other mechanisms for performing the systems and methods described in this document may be used. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

What is claimed is:

1. A method comprising:
receiving a request for content for presentation in association with one or more presentation opportunities on a publisher site;
determining one or more eligible content items based on the received request;
determining bids associated with each eligible content item;
determining a historical bid distribution for bids that have been identified when selecting content for presentation on the publisher site;
determining a risk adjustment parameter that reflects a measure of confidence in the accuracy of the historical bid distribution;
conducting an auction including scoring the determined eligible content items based on the historical bid distribution, their respective bids, and the risk adjustment parameter;
selecting a winning content item from the eligible content items based on the auction;
setting a price for the winning content item; and
providing the winning content item in response to the request.

2. The method of claim 1, wherein selecting the winning content item comprises selecting a highest bid.

3. The method of claim 2, wherein selecting the winning content item comprises selecting between at least two highest bids.

4. The method of claim 1, wherein determining the historical bid distribution for bids that have been identified when selecting content for presentation on the publisher site comprises determining a cumulative distribution function for the publisher site.

5. The method of claim 4, wherein determining the historical bid distribution for bids that have been identified when selecting content for presentation on the publisher site further comprises determining a probability density function using the cumulative distribution function for the publisher site.

6. The method of claim 4, wherein the risk adjustment parameter is a function of an amount of historical bid data available for the publisher site.

7. The method of claim 1, wherein scoring the determined eligible content items based on the historical bid distribution, their respective bids, and the risk adjustment parameter comprises, for each bid associated with a particular eligible content item, calculating a risk-adjusted virtual valuation based on the historical bid distribution, the particular bid, and the risk adjustment parameter.

8. The method of claim 7, wherein scoring the determined eligible content items further comprises generating risk-adjusted virtual valuations as a function of the bids.

9. The method of claim 8, wherein scoring the determined eligible content items further comprises generating an ironed risk-adjusted virtual valuation as a function of the bids.

10. The method of claim 9, wherein the ironed risk-adjusted virtual valuation is a non-decreasing function of the bids.

11. The method of claim 10, wherein selecting the winning content item comprises ranking the eligible content items based on their corresponding ironed risk-adjusted virtual valuations.

12. The method of claim 1, wherein setting the price for the winning content item comprising selecting the price at a bottom range associated with the one or more entities that are specifically interested in the one or more content presentation opportunities.

13. The method of claim 1, wherein setting the price for the winning content item comprising computing an average of a set of highest bids.

14. A system comprising:
one or more computer processors; and
one or more non-transitory computer readable devices that include instructions that, when executed by the one or more computer processors, causes the processors to perform operations, the operations comprising:
receiving a request for content for presentation in association with one or more presentation opportunities on a publisher site;
determining one or more eligible content items based on the received request;
determining bids associated with each eligible content item;
determining a historical bid distribution for bids that have been identified when selecting content for presentation on the publisher site;
determining a risk adjustment parameter that reflects a measure of confidence in the accuracy of the historical bid distribution;
conducting an auction including scoring the determined eligible content items based on the historical bid distribution, their respective bids, and the risk adjustment parameter;
selecting a winning content item from the eligible content items based on the auction;
setting a price for the winning content item; and
providing the winning content item in response to the request.

15. A method comprising:
receiving a request for content for presentation association with one or more presentation opportunities on a publisher site;
determining one or more eligible content items based on the received request;
determining bids associated with each eligible content item;
determining a cumulative distribution function corresponding to a distribution of bids that a plurality of advertisers have previously placed for a publisher site;
determining a risk adjustment parameter that reflects a measure of confidence in the accuracy of the historical bid distribution;
for each bid, calculating a risk-adjusted virtual valuation based on each respective bid, the cumulative distribution function, and the risk adjustment parameter;
ranking the bids based on the calculated risk-adjusted virtual valuations and selecting a winning bid based on the ranking;
setting a price for the winning bid; and
providing the winning content item in response to the request.

16. The method of claim 15, wherein the risk adjustment parameter is a function of an amount of historical bid data available for the publisher site.

17. The method of claim 16, further comprising determining a probability density function corresponding to the cumulative distribution function, wherein the calculation of the risk-adjusted virtual valuation is further based on the probability density function.

18. The method of claim 15, further comprising determining an ironed risk-adjusted virtual valuation that comprises a non-decreasing function.

19. The method of claim 15, wherein selecting the winning bid comprises selecting a non-highest bid as the winning bid.

20. The method of claim 15, wherein setting the price for the winning content item comprising computing an average of a set of highest bids.
